(19) United States
(12) Patent Application Publication
(10) Pub. No.: US 2024/0349285 A1
(43) Pub. Date: Oct. 17, 2024

(54) CONTROL METHOD, TELECOMMUNICATIONS NETWORK ENTITY, COMMUNICATION METHOD AND USER EQUIPMENT

(71) Applicant: Orange, Issy-les-Moulineaux (FR)

(72) Inventors: Joe Saad, CHATILLON CEDEX (FR); Mohamad Yassin, CHATILLON CEDEX (FR); Salvatore Costanzo, CHATILLON CEDEX (FR)

(21) Appl. No.: 18/634,463

(22) Filed: Apr. 12, 2024

(30) Foreign Application Priority Data
Apr. 13, 2023 (FR) 2303685

(51) Int. Cl. H04W 72/20; H04W 72/0453

(52) U.S. Cl. CPC H04W 72/20; H04W 72/0453

(57) ABSTRACT

A method is described, implemented by an entity of a telecommunications network, for controlling a monitoring frequency at which a user equipment monitors a control channel capable of carrying at least one indicator of a bandwidth part assigned to this user equipment. This control method includes adjusting the monitoring frequency, according to at least one characteristic of at least one data stream to be transmitted associated with the user equipment and relating to at least one service offered by the network, notifying the adjusted monitoring frequency to the user equipment; and sending information intended for the user equipment over the control channel according to the adjusted monitoring frequency.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to French Patent Application No. 2303685, filed Apr. 13, 2023, the disclosure of which is hereby incorporated by reference in its entirety.

### BACKGROUND

### Technical Field

The disclosed technology belongs to the general field of telecommunications. More particularly, it lies within the context of a telecommunications network allowing a user equipment (UE) of this network to receive or send data over only part of the bandwidth allocated by the network to the cell to which this user equipment is attached.

### Discussion of Related Technology

Such functionality, also known as BWP, for “BandWidth Part”, has been introduced, notably, in the context of a 5G (i.e. 5^{th} Generation) network, and more particularly in the context of the 5G NR (for “New Radio”) network defined by the 3GPP standard, from Release 15 onwards. The bandwidth over which data associated with a UE are transmitted (i.e. sent or received by the UE) via the network, and incidentally the numerology used by the UE over this bandwidth, can be dynamically adapted by this functionality. The numerology, in the context of an OFDM (Orthogonal Frequency Division Multiplexing) scheme such as that adopted by the 5G NR radio access technology, is taken to mean the spacing between the subcarriers and the length of the cyclic prefix, or in an equivalent manner, the OFDM symbol duration.

The use of a single numerology, as in 4G or LTE (for “Long Term Evolution”) networks, namely a spacing of 15 kHz between the subcarriers and a cyclic prefix length of about 4.7 μs, is difficult to envisage in the context of a 5G network, notably because of the multiplicity of deployment scenarios envisaged, in terms of the cell sizes, the frequency bands allocated, the resulting propagation effects (such as delay spread), the heterogeneous services offered in 5G (and the consequent highly diverse constraints), or other factors. 5G NR radio access has therefore been designed to provide a degree of flexibility in this area and to support a plurality of numerologies for a single carrier frequency, as shown in Table 1 below.

TABLE 1

| Numerology μ | 0 | 1 | 2 | 3 | 4 |
|---|---|---|---|---|---|
| Spacing Δf between the | 15 | 30 | 60 | 120 | 240 |
| subcarriers (SCS, for | | | | | |
| “SubCarrier Spacing”) | | | | | |
| (kHz). | | | | | |
| Duration Tᵤ of a payload | 66.7 | 33.3 | 16.7 | 8.33 | 4.17 |
| symbol (μs) | | | | | |
| Approximate length T_{CP} | 4.7 | 2.3 | 1.2 | 0.59 | 0.29 |
| of the cyclic prefix (μs) | | | | | |
| Total duration Tᵤ + T_{CP} of | 71.35 | 35.68 | 17.84 | 8.92 | 4.46 |
| an OFDM symbol (μs) | | | | | |
| Duration of a slot (14 | 1 | 0.5 | 0.25 | 0.125 | 0.0625 |
| OFDM symbols) or TTI | | | | | |
| (for “Transmission Time | | | | | |
| Interval”) (ms) | | | | | |

By using these multiple numerologies, it is advantageously possible to meet the diverse and varied constraints (also denoted SLA, for “Service Level Agreement”) in terms of latency, throughput and reliability imposed by the various categories of service that can be offered by 5G networks. These different service categories comprise, notably:
eMBB (for “enhanced Mobile Broadband”) services, based on very high data rates, for offering new experiences to users (e.g. virtual reality, augmented reality, HD video broadcasting, etc.);
uRLLC (for “ultra Reliable Low Latency Communication”) services, which have strict requirements regarding the latency and reliability of communications (e.g. remote operation services, industrial robots, and remote surgery);
mMTC (“massive Machine Type Communication”) services, including, notably, the Internet of Things (IoT), which have high requirements, notably in terms of deployment density (e.g. connected cities, connected agriculture, etc.);
V2X (for “Vehicle to Everything”) services, enabling a vehicle to exchange data with another vehicle, infrastructure elements, the network and/or a pedestrian. V2X services include safety services, for example those with the aim of minimizing accidents and risks to passengers or road users (e.g. driver assistance or autonomous driving), which require a very low latency (less than a few milliseconds) and a transmission reliability close to 100%, and other, non-safety services which are more concerned with improving traffic conditions, minimizing the effect of road congestion, improving the comfort of passengers in vehicles, etc., and which, while requiring high transmission rates, can tolerate a degree of latency and lower reliability; and
HMTC (“High performance Machine Type Communications”) services, which, like mMTC services, have high requirements in terms of deployment density (and therefore of communication resource availability), while also requiring low latency and high transmission rates.

Thus, for example, as shown in Table 1, a high numerology (corresponding to a subcarrier spacing of 120 kHz, for example) can reduce the duration of a transmission time or TTI, and incidentally the latency: it is therefore particularly suitable for uRLLC services. Conversely, a lower numerology may be used to obtain a higher data rate, and is particularly suitable for eMBB services.

As mentioned above, the 5G NR radio access technology enables a UE, via the BWP functionality, to use a narrower bandwidth than the total bandwidth allocated by a 5G network to the cell in which the UE is located. This narrower bandwidth corresponds to a part (denoted BWP below) of the total bandwidth allocated by the network to the cell. Because of the bandwidths envisaged for 5G (up to 400 MHz for a single carrier), the use of this functionality makes it possible, on the one hand, to adapt to UEs having reduced capacity in terms of the bandwidth that is supported and/or that they can monitor, and, on the other hand, to reduce the complexity of the processing performed by the UEs (e.g. monitoring and decoding of control channels) and thus their power consumption.

Each BWP is characterized by a numerology (subcarrier spacing and cyclic prefix length) and by a number of consecutive physical resource blocks (PRB) conforming to this numerology. It begins at a particular common resource block (CRB), the location of which is identified relative to a CRB acting as a reference point for all the numerologies, also called “reference point A”. Different BWPs may use the same numerology, while having different bandwidths.

It should be noted that, in the 5G NR context, a resource block (RB) (such as a PRB or a CRB) is an element defined in the frequency domain, consisting of 12 consecutive subcarriers. The frequency spreading of an RB therefore depends on the numerology concerned: thus, for example, 2 consecutive RBs for a numerology based on a spacing Δf between the subcarriers occupy the same frequency band as one RB for a numerology based on a spacing of 2Δf between the subcarriers. A PRB is therefore the smallest radio unit assigned to a UE in the 5G NR context.

FIG. 1 shows schematically the concept of a BWP. In this figure, two bandwidth parts, denoted BWP1 and BWP2, are considered, these bandwidth parts being defined within the bandwidth BW associated with a carrier C allocated to a cell of a 5G network. In the example of FIG. 1, the bandwidth parts BWP1 and BWP2 are respectively associated with two separate numerologies, corresponding to respective spacings of Δf and 2Δf between the subcarriers. The PRBs, and CRBs respectively, corresponding to the spacings of Δf and 2Δf between the subcarriers, are denoted PRB(Δf) and CRB(Δf) respectively, and PRB(2Δf) and CRB(2Δf) respectively. The bandwidth part BWP1 begins at block CRB(Δf) #m, relative to reference point A, and consists of M consecutive PRB(Δf)s, corresponding to a spacing of Δf between the subcarriers; the bandwidth part BWP2 begins at block CRB(2Δf) #n and consists of N consecutive PRB(2Δf)s, corresponding to a spacing of 2Δf between the subcarriers, M and N denoting two integers greater than or equal to 1.

According to the 3GPP standard, in a UE, four BWPs can be configured in downlink (DL) and four BWPs can be configured in uplink (UL) for the transmission of data associated with the UE. Here, the expression “transmission of data associated with the UE” covers, in a general manner, the reception of data by the UE and/or the sending of data by the UE.

Depending on the service(s) used by a UE, the activation of one BWP may be found to be more appropriate than another, notably because of the numerology associated with this BWP. This is because, as pointed out above, the higher numerologies are particularly suitable for services requiring low latency, such as uRLLC services, whereas the lower numerologies are more suitable for eMBB services requiring very high data rates. Consequently, it is not optimal to use the same numerology for two services having different constraints (or SLAs).

Now, one UE in a 5G network may be connected simultaneously to different services. For example, the 3GPP standard has introduced the concept of “network slicing”, by which a 5G physical network can be divided into a plurality of logical “slices”, each logical slice being associated with a separate service, characterized by its own SLA and having dedicated radio resources. The same UE can be connected to 8 network slices simultaneously and can therefore access separate services simultaneously. It should be noted that a UE of a 5G network can be connected to a plurality of separate services even in the absence of network slicing.

The document U.S. Pat. No. 10,880,949 proposes a signaling mechanism for the parallel activation of a plurality of BWPs (for simultaneous use, or overlapping in time) at a UE. Such activation advantageously allows the simultaneous connection of a UE to a plurality of services, for example by configuring separate BWPs for services having different constraints. Because of this mechanism, the latency is reduced and service interruptions are limited. However, this mechanism is incompatible with some limitations set by the 3GPP standard for UEs in the context of BWP functionality.

In fact, according to the 3GPP standard, although a plurality of BWPs can be configured at the UE, only one BWP can be active (in other words, used for transmitting data associated with the UE) at a given instant in UL or DL. However, a UE can sometimes switch from one BWP to another; in other words, it can activate a new BWP to replace the current active BWP. Such a switch may be decided by the network (the base station to which the UE is attached), for example in order to meet the quality of service (QoS) requirements of a new service required by the UE, the new BWP being considered to be more suitable, because of its numerology, than the current active BWP for transmitting the data stream for this service. Such a switch is triggered by the base station which sends downlink control information (DCI), in a physical downlink control channel (PDCCH), to the UE, in 0_1 format (for the UL) or 1_1 format (for the DL), comprising a BWP indicator designating the new BWP to be activated by the UE. The control channel PDCCH is broadcast by the base station in the cell that it covers; the UE is configured by the network operator to periodically monitor this control channel PDCCH so as to detect the information sent by the base station relating to it (notably, the control information DCI and, if appropriate, the BWP indicators designating the BWPs to be activated).

The paper by K. Boutiba et al., entitled “Radio Resource Management in Multi-numerology 5G New Radio featuring Network Slicing”, IEEE International Conference on Communications (ICC), May 2022, proposes an algorithm based on deep reinforcement learning (DRL), for allocating resources to UEs connected to multiple network slices associated with different SLAs and for multiplexing the numerologies assigned to them, while ensuring that only one BWP is active at any given instant in a UE. To allow for the connection of one UE to multiple network slices, the UE is modeled as a plurality of virtual UEs, each virtual UE being connected to a single network slice; additionally, two constraints are imposed on the time resources allocated to the virtual UEs associated with the same UE, namely that they must use the same numerology and must not intersect.

Consequently, this algorithm does not allow different numerologies to be associated with different services to which a UE is connected. As pointed out above, the use of the same numerology for services having different quality of service requirements or different priorities is not optimal.

Furthermore, the modeling on which the algorithm is based does not take into consideration the delays required for assigning the resources to the UEs and for signaling the changes of BWP to them where necessary.

Thus there is a need for a mechanism for the efficient implementation of a BWP functionality as defined by the 3GPP standard, in a network allowing a user equipment to connect to multiple heterogeneous services, typically having different priorities and/or requirements in terms of quality of service.

### SUMMARY

The disclosed technology enables this need to be met, notably, by proposing a method enabling an entity of a telecommunications network to control what is known as a monitoring frequency, at which a user equipment monitors a control channel capable of carrying at least one indicator of a bandwidth part assigned to said user equipment, said control method comprising:
a step of adjusting said monitoring frequency, according to at least one characteristic of at least one data stream to be transmitted associated with said user equipment and relating to at least one service offered by the network;
a step of notifying said adjusted monitoring frequency to said user equipment; and
a step of sending information intended for the user equipment over said control channel according to said adjusted monitoring frequency.

In correlation, the disclosed technology also relates to a telecommunications network entity comprising:
an adjustment module, configured to adjust, according to at least one characteristic of at least one data stream to be transmitted associated with a user equipment and relating to at least one service offered by said network, a quantity representing a frequency of monitoring a control channel capable of carrying at least one indicator of a bandwidth part assigned to said user equipment;
a notification module, configured to notify said adjusted monitoring frequency to said user equipment; and
a sending module, configured to send information intended for the user equipment over said control channel according to said adjusted monitoring frequency.

The telecommunications network entity is, for example, a base station of the network (also called gNB in the context of a 5G network). This may be a hardware or a software entity, which may be distributed over one or more network functions or may be hosted by one or more hardware equipments.

The disclosed technology therefore proposes the dynamic adjustment of the frequency of user equipment's monitoring of the control channel carrying the information relating to the BWPs to be activated at the user equipment, for the purpose of transmitting the traffic (UL or DL traffic) relating to the services to which this user equipment is connected, and for the purpose of using this adjusted monitoring frequency for transmitting these data. The expression “adjustment of the frequency of the user equipment's monitoring of the control channel” is taken to mean that the number of times that the user equipment performs this monitoring within a given period is adjusted. The parameter that is acted on in order to adjust this monitoring frequency is of little significance for the disclosed technology. Thus, if the monitoring is periodic, the parameter may be the period with which the monitoring is reiterated in time, or the inverse of this period, and so on.

There is no limit on the number or type of services to which the traffic relates. Thus, for example, said at least one service offered by the network may comprise at least one of the following services:
an “ultra Reliable Low Latency Communication” (uRLLC) service;
an “enhanced Mobile BroadBand” (eMBB) service;
a “massive Machine Type Communication” (mMTC) service;
a “Vehicle to Everything” (V2X) service;
a “High Performance Mobile Type Communication” (HMTC) service.

These services are defined by the 3GPP standard, and correspond to different and varied constraints in terms of latency, reliability, etc., as mentioned above. Evidently, the disclosed technology is not limited to these services, and other services, alternative or complementary in nature, may be envisaged in the context of the disclosed technology, with similar or identical constraints, or with constraints different from those of the aforesaid services.

The adjustment proposed by the disclosed technology is advantageously performed taking into account the characteristics of this traffic (typically the services to which this traffic relates, the priority granted to these services or to these streams, the latency supported by these services or these streams, the volumes to be transmitted, etc.). It is therefore suitable for the user equipment in question. The characteristics of the traffic associated with the user equipment enable the network entity to estimate whether information intended for the user equipment should be sent over the control channel in order to optimize this traffic, and, if necessary, to control the schedule according to which this information can be sent to the user equipment and then detected and taken into consideration by the latter.

Typically, this information intended for the user equipment may comprise at least one indicator of the BWP assigned by the network entity to the user equipment (with the aim of optimizing the transmission of the traffic associated with the user equipment, for example) and to be activated for the transmission of the traffic associated with the user equipment (incoming or outgoing data stream(s)).

Thus the disclosed technology makes it possible to benefit from the adjusted monitoring frequency and sending frequency for the purposes of notifying a change of BWP to the user equipment. The disclosed technology enables the network entity to control and adapt the moment at which the user equipment is notified of the BWP that it must activate, according to the urgency and the constraints of the traffic associated with this user equipment.

For example, in a particular embodiment, the adjustment step comprises increasing the monitoring frequency when at least two separate bandwidth parts are assigned to said user equipment for the transmission of said at least one data stream and when at least one said service and/or at least one said data stream is identified as taking priority or as being associated with a maximum latency below a given threshold.

Conversely, in one embodiment, the adjustment step comprises a reduction of the monitoring frequency when one of the following conditions is met:
the same bandwidth part is assigned to said user equipment for the transmission of said at least one data stream;
said at least one service comprises only one or more services identified as non-priority or associated with a maximum latency above a given threshold;
said at least one stream comprises only one or more streams identified as non-priority or associated with a maximum latency above a given threshold.

Typically, a service, or a data stream, identified as taking priority (i.e. identified as a priority service or a priority data stream respectively) is a service or a data stream that often has high requirements in terms of latency (supporting a maximum latency of less than 1 ms, for example), such as a uRLLC or V2X service, for example, or a Delay Critical GBR (Guaranteed Bit Rate) QoS stream.

This is because, if some or all of the traffic associated with a user equipment relates to a service identified as taking priority or tolerating low latency, it is desirable for the switch to a BWP suitable for this type of service (associated with a high numerology, for example) to take place as rapidly as possible, in order to reduce latency and limit the risks of interruption of this service. This is also true for a data stream that takes priority or tolerates low latency, including a stream relating to a non-priority service. To this end, the network entity can then advantageously, in the adjustment step, increase the control channel monitoring frequency so that the user equipment can be informed as rapidly as possible of the BWP assigned to it for this priority service or stream, and can activate it without undue delay.

Conversely, if the traffic associated with the user equipment does not relate to a priority service or stream or one having high requirements in terms of latency (an eMBB service, for example), or if it requires no change in the BWP, the network entity may, in the adjustment step, reduce the monitoring frequency in order to limit the power consumption of the user equipment and conserve the network resources.

Thus the disclosed technology allows optimized and efficient management of the BWP functionality, notably in a context where a change of BWP is envisaged. Preferably, but not exclusively, it may be applied when the user equipment is connected to a plurality of services having heterogeneous constraints or different priorities, because it allows the network operator to activate a BWP suitable for each service, without latency, in order to optimize the transmission of the traffic associated with the user equipment.

The disclosed technology also provides a considerable gain over other approaches in which the control channel carrying the BWP indicators is monitored periodically by the user equipment with a fixed period, configured by the network operator at the user equipment via an RRC (Radio Resource Control) message sent by the base station during the establishment of the connection of the user equipment to the network. Such a period is applied to all the user equipments attached to the base station, and is typically set by the operator to be equal to a plurality of slots (e.g. 5 or 8 slots) or TTIs, representing a number of milliseconds for the μ=0 numerology. Evidently, therefore, if a change of BWP is decided on by the base station for transmitting data streams associated with a user equipment in relation to a uRLLC service, requiring a latency of less than a millisecond, the base station must wait for the sending of the next control channel comprising information intended for the user equipment in order to transmit this instruction to the equipment, entailing a potential wait of several milliseconds, depending on the value of the period configured by the operator, which may adversely affect the quality of the uRLLC service.

Conversely, in the disclosed technology, the control channel monitoring frequency and the frequency of sending information intended for the user equipment over the control channel (including the BWP indicators, if appropriate) can be adjusted and are suitable for each user equipment according to its traffic and the services to which it is connected. The disclosed technology makes it easy to achieve a compromise between latency and power consumption of the user equipment, and to meet the differing and varied constraints of the services that a user can access.

Furthermore, it is relatively simple to implement, since it is based on the modification of the frequency of the user equipment's monitoring of the control channel, which can easily be configured by the network operator, via an RRC message for example. It is also compatible with the constraint set by the 3GPP standard, according to which a user equipment can only have one BWP active at a given instant (although it should be noted that the disclosed technology is also applicable in the absence of this constraint), and, subject to this constraint, it makes it possible to optimize the transmission of the traffic associated with a user equipment connected to multiple services.

The disclosed technology is therefore preferably applicable in the context of a 5G NR network as described above. In this context, the disclosed technology is essentially concerned with the dynamic adjustment of the period of the periodic monitoring performed by the user equipment of the PDCCH channel broadcast by the base station to the cell, and with using this adjusted period to send the control information DCI more efficiently to the user equipment in the PDCCH channel. The flexibility offered by the disclosed technology makes it particularly suitable in the context of a 5G network using network slicing, in which a plurality of network slices can be used to offer a plurality of services to the network users.

However, the disclosed technology is applicable in other contexts and to other network architectures, for example in a network of a future generation (6G, etc.), or a proprietary network, or an Open-RAN architecture as defined by the O-RAN Alliance, implementing a BWP functionality, in which a user equipment can be connected simultaneously to multiple services. In the context of an Open-RAN network architecture, the control method according to the disclosed technology can be implemented by a near-real time RAN intelligent controller (near-RT RIC), for example in a software application also known by the name of xAPP (a network entity according to the disclosed technology).

It should also be noted that the disclosed technology is equally applicable in both uplink (UL), to facilitate the transmission of outgoing streams from the user equipment, and in downlink (DL), to facilitate the transmission of incoming streams for the user equipment, regardless of the resource multiplexing scheme envisaged in the network between the UL and DL channels (for example, time division multiplexing (TDD) or frequency division multiplexing (FDD)). The disclosed technology is applied in each channel individually. If the same channel carries information relating to the uplink and the downlink, and a different adjustment of the monitoring frequency is used for the uplink and the downlink, then the highest of the two adjusted monitoring frequencies is chosen for application by the user equipment.

In a particular embodiment, said at least one stream characteristic taken into consideration by the network entity in the adjustment step may comprise, for a said data stream associated with a said service:
a volume of said data stream; and/or
information about a scheduling of the data packets carried by said data stream and about a bandwidth part assigned to said service for the transmission of said data packets; and/or
a priority associated with said data stream and/or a maximum latency associated with said data stream; and/or
a priority associated with said service; and/or
a network slice associated with said service.

Such characteristics advantageously reflect the volume of incoming or outgoing traffic, the scheduling of this traffic, and the services to which the user equipment is connected, as well as their constraints and priorities. This type of characteristic can affect the way in which the transmission of the traffic is organized with the aim of optimization, and thus enables the entity to adjust the monitoring frequency in a well-informed way. Evidently, these examples of stream characteristics are not limiting in themselves, and other characteristics may be considered. Furthermore, the characteristics considered in the adjustment step may be characteristics representative of the real traffic associated with the user equipment, or may consist of an estimate or a prediction of this traffic.

In a particular embodiment, the steps of adjusting the monitoring frequency, notifying the adjusted monitoring period and sending are reiterated periodically.

For example, the adjustment of the monitoring frequency may be revised once per frame (that is to say, every 10 ms in the context of a 5G NR network).

The period (called the adjustment period) with which the adjustment, notification and sending steps are reiterated may, notably, affect the duration over which the characteristics of the traffic associated with the user equipment are considered for adjusting the monitoring frequency.

This embodiment offers further flexibility: it enables the adjustment applied to the monitoring frequency to be revised, if necessary, according to the variation of the traffic, and, if relevant, according to the services to which the user equipment is connected, the appearance of the traffic, etc.

It may also be envisaged, in a particular embodiment, that there should be an adjustment period that can be configured by the network entity, for example according to the context in which the user equipment is situated (e.g. its location) or the services to which it is connected.

In a variant, the steps of adjusting the monitoring frequency, notification and sending may be triggered on the detection of a particular event, such as the connection of the user equipment to a new service.

In a particular embodiment, in the adjustment step, the monitoring frequency is also adjusted on the basis of at least one key performance indicator (KPI) of said user equipment and/or of the network.

Said at least one key performance indicator may comprise, for example:
the power consumption of said user equipment; and/or
the end-to-end data rate or latency of the network.

Thus, for example, the increase or reduction of the monitoring period may be evaluated (designed) according to at least one such key performance indicator of said user equipment and/or of the network. By taking such key performance indicators into account, it is possible to make compromises in the adjustment of the monitoring period, without sacrificing the KPIs of the user equipment and/or of the network that may affect the user equipment and/or that play an important part for the network operator. This results in an optimized implementation of the BWP functionality in the network.

By way of illustration, an increase in the monitoring frequency may be conditioned by the power consumption of the user equipment. In fact, an increase in the monitoring frequency will lead to an increase in the activity of the user equipment, which must be capable of listening to and processing the more frequent information sent to it, and therefore, incidentally, an increase in the power consumption of the equipment. It is therefore important to ensure that this increase in power takes place within reasonable limits that are acceptable for the user equipment, in order to economize on its resources, notably its battery.

As mentioned above, the stream characteristics taken into account for the adjustment of the monitoring frequency may be real characteristics of these streams, or may be the result of estimation or prediction. They may also be determined by the network entity on the basis of information collected from different sources.

Thus, in a particular embodiment, the control method further comprises a step of estimating said at least one characteristic of said at least one data stream to be transmitted, associated with said user equipment on the basis of at least one of the following parameters:
at least one identifier of at least one network slice to which said user equipment is attached or which is authorized for said user equipment, and/or at least one service to which said user equipment is connected or is authorized to connect; and
at least one piece of information supplied by said user equipment.

This embodiment is advantageously based on information that is already known or supplied to the network, in order to obtain a reliable and precise prediction of the characteristics of the traffic to be transmitted, associated with a user equipment, and in order to make the best adjustment of the control channel monitoring frequency and the frequency of sending data intended for the user equipment in this control channel.

In a particular embodiment, the control method further comprises a step of learning a traffic prediction model for said user equipment, said prediction model being used by said network entity for determining said at least one characteristic of said at least one stream to be transmitted associated with said user equipment.

There are no limits on the nature of the prediction model learned during the learning stage and used to determine the characteristics of the traffic associated with the user equipment. For example, this prediction model may be based on a neural network, a reinforcement or deep reinforcement learning algorithm, a mathematical model or a heuristic, etc.

In view of the above, the disclosed technology is applied not only to the network entity that implements the control method according to the disclosed technology for the purpose of adjusting the control channel monitoring frequency and the frequency of sending information in this control channel intended for the user equipment, but also to the user equipment itself.

Thus, according to another aspect, the disclosed technology also proposes a method of communication by a user equipment of a telecommunications network, this method comprising:
a step of receiving a notification of what is known as a monitoring frequency at which said user equipment monitors a control channel, said monitoring frequency being adjusted by a network entity according to an adjustment step of a control method according to the disclosed technology, said control channel being capable of carrying at least one indicator of a bandwidth part assigned to said user equipment; and
a step of monitoring said control channel according to said adjusted monitoring frequency.

In correlation, the disclosed technology also relates to a user equipment of a telecommunications network comprising:
a reception module, configured to receive a notification of what is known as a monitoring frequency at which said user equipment monitors a control channel, adjusted by an adjustment module of a network entity according to the disclosed technology, said control channel being capable of carrying at least one indicator of a bandwidth part assigned to said user equipment; and
a monitoring module, configured to monitor said control channel according to said adjusted monitoring frequency.

In a particular embodiment, the communication method according to the disclosed technology further comprises, in said monitoring step, detecting in said control channel at least one indicator of a bandwidth part assigned to the user equipment to be activated.

In a particular embodiment of the communication method, said notification is an RRC (radio resource control) configuration message, sent by the network entity and comprising a value of a period with which the monitoring of the control channel is to be reiterated.

The communication method and the user equipment according to the disclosed technology benefit from the same aforementioned advantages as the control method and the network entity.

In one particular embodiment, the control and communication methods are implemented by a computer.

The disclosed technology also proposes a computer program on a recording medium, this program being able to be implemented in a computer or more generally in a telecommunications network entity according to the disclosed technology and comprising instructions designed to implement a control method as described above.

The disclosed technology also proposes a computer program on a recording medium, this program being able to be implemented in a computer or more generally in a user equipment according to the disclosed technology and comprising instructions designed to implement a communication method as described above.

Each of these programs may use any programming language, and be in the form of source code, object code, or of intermediate code between source code and object code, such as in a partially compiled form, or in any other desirable form.

The disclosed technology also targets a computer-readable information medium or recording medium including computer program instructions, such as mentioned above.

The information medium or recording medium may be any entity or device capable of storing the programs. For example, the medium may include a storage means, such as a ROM, for example a CD-ROM or a microelectronic circuit ROM, or else a magnetic recording means, for example a hard disk, or a flash memory.

Moreover, the information medium or recording medium may be a transmissible medium such as an electrical or optical signal, which may be routed via an electrical or optical cable, by radio link, by wireless optical link or by other means.

The program according to the disclosed technology may in particular be downloaded over the Internet.

As an alternative, the information medium or recording medium may be an integrated circuit in which a program is incorporated, the circuit being designed to execute or to be used in the execution of the control and communication methods according to the disclosed technology.

According to another aspect, the disclosed technology also proposes a communication system comprising:
at least one network entity of a telecommunications network according to the disclosed technology; and
at least one user equipment according to the disclosed technology, attached to said at least one entity of the network.

It is also possible, in other embodiments, to envisage the control and communication methods, the network entity, the user equipment communication system according to the disclosed technology having all or some of the abovementioned features in combination.

### BRIEF DESCRIPTION OF THE DRAWINGS

Other features and advantages of the disclosed technology will emerge from the description given below, with reference to the appended drawings that illustrate one exemplary embodiment thereof that is in no way limiting. In the figures:

FIG. 1, described above, shows the bandwidth parts (BWPs) defined on the basis of a nominal bandwidth allocated to a network;

FIG. 2 shows a communication system in a telecommunications network, according to the disclosed technology, in one particular embodiment;

FIG. 3 schematically shows the hardware architecture of a computer on which are based a network entity and a user equipment according to the disclosed technology, belonging to the communication system of FIG. 2;

FIG. 4 shows, in the form of a flowchart, the main steps of a control method according to the disclosed technology, as implemented by a network entity according to the disclosed technology belonging to the communication system of FIG. 2;

FIG. 5 shows, in the form of a flowchart, the main steps of a communication method according to the disclosed technology, as implemented by a user equipment according to the disclosed technology belonging to the communication system of FIG. 2;

FIGS. 6 and 7 show, in an example, the gain provided by the disclosed technology, with FIG. 6 showing an example in the absence of the disclosed technology;

FIG. 7 shows the example with the disclosed technology implemented; and

FIG. 8 shows an embodiment of the disclosed technology based on an Open-RAN architecture.

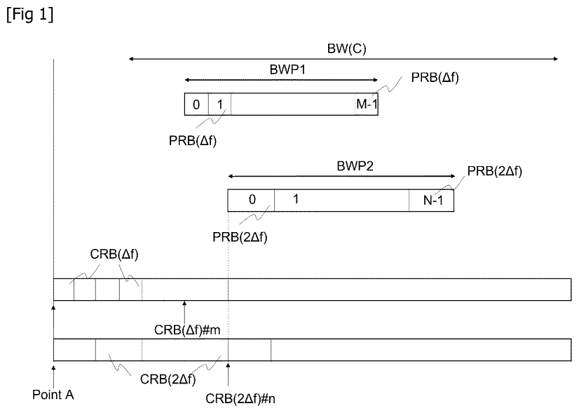

### DETAILED DESCRIPTION

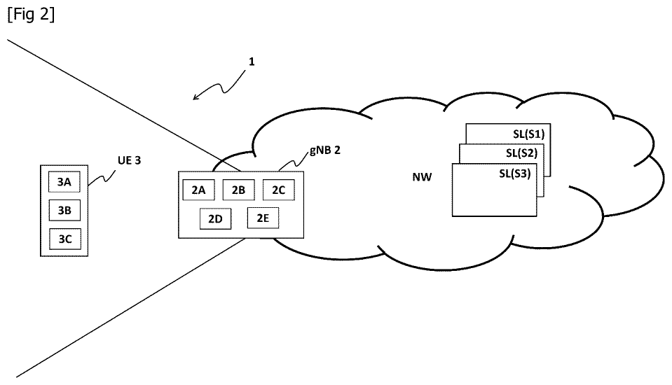

FIG. 2 shows, in its environment, a communication system 1 according to the disclosed technology, in one particular embodiment.

In this embodiment, the system 1 comprises:
at least one entity 2 of a telecommunications network NW according to the disclosed technology; and
at least one user equipment or UE 3 of the telecommunications network NW, attached to said at least one entity 2, and according to the disclosed technology.

In the remainder of the description and in FIG. 2, for the sake of simplicity, a single entity 2 and a single user equipment 3, attached to this entity 2, are considered.

In the example of FIG. 2, the telecommunications network NW is a 5G NR network as defined by the 3GPP standard (except as regards the adaptations required for the implementation of the disclosed technology, described below). It implements, notably, the aforementioned BWP functionality, enabling a user equipment to use only a part of the total bandwidth allocated to the cell to which it is attached, whether this be in DL for receiving data and/or in UL for sending data.

In this context, the entity 2 according to the disclosed technology is a base station (also called gNode B or gNB) of the network NW, covering at least one cell CELL of the network NW to which the UE 3 is attached and via which the UE 3 can access the services offered by the network NW. It is assumed here that the cell CELL is configured with at least one carrier frequency CF, to which the operator of the network NW has allocated a bandwidth BW(CF). Thus the BWP functionality allows the UE 3 to use for transmission (in DL or UL) only a part (BWP) of the bandwidth BW(CF) associated with a certain numerology p, when it is attached to the cell CELL. The UE 3 is informed of the BWP (and the associated numerology) that has been assigned to it by the gNB 2 and that it must use (i.e. activate) at a given instant, via control information DCI intended for the UE 3 and sent by the gNB 2 in a PDCCH control channel (broadcast to the cell CELL).

The DCI control information carried in the PDCCH control channels may have different formats depending on the elements that it carries. The DCI control information in a 0_1 format (dedicated to the UL) or in a 1_1 format (dedicated to the DL) contain, in addition to the location of the resources in time and frequency allocated in UL and/or in DL to the UE 3, an indicator of a BWP to be activated by the latter, this indicator designating in a unique manner a BWP to be activated by the UE 3 and the associated numerology to be used. The 0_1 and 1_1 formats of the DCI control information and the elements that they contain, together with the other formats of DCI control information proposed by the 3GPP standard, are described, notably, in paragraph 7.3 of the 3GPP document TS 38.212 entitled “Technical Specification Group Radio Access Network; NR; Multiplexing and channel coding (Release 17)”, v17.5.0, March 2023. Thus the PDCCH channel is a control channel capable of carrying a BWP indicator in the sense of the disclosed technology.

In a known manner, the UE 3 is configured to monitor periodically, with a period T_{PDCCH}, the PDCCH channel in order to detect whether it contains information intended for it, such as the DCI information, and more particularly a BWP indicator designating the BWP to which it must switch. The period T_{PDCCH} is therefore a parameter representative of the frequency at which the UE 3 monitors the PDCCH channel.

It also follows from this configuration that, if the gNB 2 has information to transmit to the UE 3, particularly DCI information and BWP indicators, it sends them in the PDCCH channel in a manner compatible with this period T_{PDCCH} so that the UE 3 can detect and decode them. In other words, the sending of a BWP indicator to the UE 3 by the gNB 2 is not necessarily periodic (some DCI information contains no BWP indicator, depending on the format of this DCI information), but when the DCI information is sent to the UE 3 by the gNB 2, the sending takes place in the current active BWP of the UE 3 at an instant coinciding with the period T_{PDCCH} with which the UE 3 periodically monitors the PDCCH channel.

The period T_{PDCCH} is configured in the UE 3 by the gNB 2 during the RRC reconfiguration when a connection between the UE 3 and the gNB 2 is established. For example, let us assume that the period T_{PDCCH} is initially set by the network operator to be equal to a number of slots (or TTIs) corresponding to the numerology μ=0 (e.g. 5 slots corresponding to T_{PDCCH}=5 ms). In the embodiment described here, according to the disclosed technology, this period T_{PDCCH} is adjustable and can change over time, as detailed below.

It should be noted that the disclosed technology may be applied in other contexts or to other architectures than that described here, for example in an Open-RAN context (as described in greater detail below) or in a future generation network, or possibly in a proprietary network, provided that this implements a BWP functionality allowing a user equipment of the network to use only a part of the bandwidth allocated to the cell to which it is attached for transmitting (i.e. sending and/or receiving) data.

In a known manner, the telecommunications network NW allows a plurality of services to be offered to its subscribers, each service being associated with specific constraints, notably in terms of latency, transmission reliability, etc., defined by an SLA (service level agreement). By way of illustration, the following services are considered here for the network NW:
an eMBB service S1 (e.g. virtual reality, augmented reality, HD video broadcasting, etc.), requiring high data transmission rates;
a uRLLC service S2 (e.g. autonomous driving or remote management) requiring a low latency (less than a millisecond) and high reliability of data transmission; and
a mMTC service S3 (e.g. IoT), with a high requirement in terms of deployment density.

Service S2 is typically identified as taking priority (i.e. as being a priority service), because of its requirements in terms of latency (below a given threshold, namely 1 ms for uRLLC services).

In the embodiment described here, the network NW implements network slicing. Each slice is a logical sub-network based on the physical infrastructure of the network NW, to which specific resources (e.g. hardware and software resources, etc.) are allocated. The various slices SL of the network are therefore advantageously isolated from each other and can access their own resources.

Here, each slice offers a separate service, and is identified by a unique slice identifier, such as an S-NSSAI (“single-network slice selection assistance information”) identifier defined in the 3GPP standard. Thus, in the example of FIG. 2, the slice SL(S1) is configured to offer the service S1 and is identified by the identifier S-NSSAI1, the slice SL(S2) is configured to offer the service S2 and is identified by the identifier S-NSSAI2, and the slice SL(S3) is configured to offer the service S3 and is identified by the identifier S-NSSAI3. Consequently, according to this configuration, the identifier S-NSSAIn associated with a slice SL(Sn), where n denotes an integer equal to 1, 2 or 3 in the example considered, not only identifies this slice uniquely, but also identifies the service Sn that it offers.

It is assumed here by way of illustration that the UE 3 is connected simultaneously to multiple slices of the network, and more particularly to the slices SL(S1) and SL(S2) via which it can access the services S1 and S2.

Evidently, these assumptions are not limiting in themselves and this example is given solely by way of illustration. Thus, other services may be offered by the network NW in addition to, or as variants of, the aforesaid services, such as a V2x service (which may, depending on the scenario envisaged, require a latency of less than a few milliseconds and a reliability close to 100% (for what are known as “Safety-related V2x” scenarios, including autonomous driving for example), or, in a variant, a high transmission rate, a higher latency and low reliability (for what are known as “Non-safety-related V2x” scenarios, including, for example, high-speed mobile entertainment products), an HMTC service (requiring low latency, high availability and high speeds), and others. The network NW may also offer a number of separate services in each category.

The UE 3 may also be connected to a different number of slices and/or to different services. In fact, as mentioned above, according to the 3GPP standard, a UE can be connected to one or more slices (up to 8 simultaneously).

Finally, the network NW may be envisaged as offering a plurality of services having different constraints without using network slicing. In this case, each service offered by the network NW is identified in a unique way, by means of a service identifier for example.

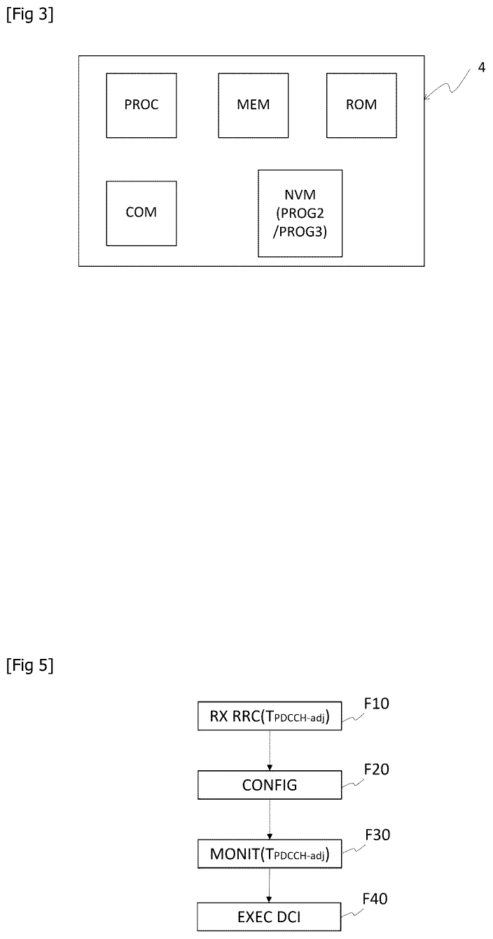

In the embodiment described here, the gNB 2 and the UE 3 have the hardware architecture of a computer 4, as illustrated in FIG. 3. This hardware architecture comprises, notably, a processor PROC, a random access memory MEM, a read-only memory ROM, a non-volatile memory NVM, and communication means COM enabling the gNB 2 and the UE 3, notably, to communicate with each other. The non-volatile memory NVM constitutes a recording medium according to the disclosed technology, readable by the processor PROC, and on which a program according to the disclosed technology is recorded.

This program, denoted PROG2 when the hardware architecture of the computer 4 is that of the gNB 2, is recorded in the non-volatile memory NVM and comprises instructions defining the main steps of a control method according to the disclosed technology as implemented by the gNB 2 (a network entity in the sense of the disclosed technology). More specifically, it defines the functional modules of the gNB 2, which are based on and/or control some or all of the aforesaid elements PROC, MEM, ROM, NVM, and COM of the computer 4.

In the embodiment described here, the program PROG2 defines, notably, the following functional modules of the gNB 2 (shown in FIG. 2), which are activated for each UE of the cell CELL for which the gNB 2 is requested to transmit data associated with this UE (the UE 3 in the example envisaged here), in UL or in DL:
a determination module 2A, configured to determine, over a given period of time, at least one characteristic of the data stream(s) to be transmitted associated with this UE, and more particularly, in this case, for each data stream, the service and/or the priority associated with this service, the priority and/or maximum latency supported by this stream, and the corresponding volume (that is to say, the number of packets to be transmitted, carried by this stream);
a scheduling module 2B or scheduler, configured so that, on the basis of the stream characteristics determined by module 2A, it decides on the time and frequency resources to be allocated to the transmission of these streams (PRBs allocated to the UE and instants of transmission of these PRBs) and their scheduling, taking into account, notably, the requirements of the services relating to these streams as indicated in the SLAs. The scheduling module 2B is responsible, notably, for deciding on the BWP and the associated numerology to be used by the UE for transmitting these streams;
an adjustment module 2C, configured to adjust, according to some or all of the stream characteristics obtained, the frequency with which the UE monitors the control channel PDCCH, referred to here as the PDCCH control channel monitoring frequency;
a notification module 2D, configured to notify the monitoring frequency adjusted by the adjustment module 2C to the UE; and
a sending module 2E, configured to send to the UE, taking into account the adjusted monitoring frequency, the information intended for it in the PDCCH control channel, and in particular the DCI control information containing the BWP indicators that the UE must, if appropriate, activate successively for the transmission of the streams associated with it.

The functions performed by the modules 2A to 2E of the gNB 2 are described in more detail below, with reference to the steps of the control method according to the disclosed technology. It should be noted that the determination module 2A and the scheduling module 2B are optional, since the gNB 2 may, in a variant, obtain the characteristics of the streams associated with a UE (a prediction of these characteristics, for example) from a network function of the network NW called the data analysis function, also known as an NWDAF (network data analysis function), in the context of a 5G network.

Similarly, if the hardware architecture of the computer 4 is that of the UE 3, the computer program recorded in the non-volatile memory NVM is denoted PROG3 and comprises instructions defining the main steps of a communication method according to the disclosed technology as it is implemented by the UE 3. More specifically, it defines the functional modules of the UE 3, which are based on and/or control some or all of the aforesaid elements PROC, MEM, ROM, NVM, and COM of the computer 4.

The program PROG3 defines, notably, the following functional modules of the UE 3 (shown in FIG. 2):
a reception module 3A, configured to receive a notification of the monitoring frequency adjusted by the adjustment module of the gNB 2; and
a monitoring module 3B, configured to monitor the PDCCH control channel broadcast by the gNB 2 to the cell CELL, according to the adjusted monitoring frequency notified to module 3A.

In the embodiment described here, the program PROG 3 also defines an activation module 3C of the UE 3, known in itself, and configured for applying the DCI information sent by the gNB 2 in the PDCCH control channel. In particular, module 3C is configured to activate each BWP that may be indicated in the DCI information carried by the PDCCH channel, in a manner that is known in itself and is not detailed here. For example, the activation module 3C proceeds here in a similar or identical fashion to what is defined in 3GPP document TS 38.101-2 entitled “Technical Specification Group Radio Access Network; NR; User Equipment (UE) radio transmission and reception; Part 2: Range 2 Standalone (Release 18)”, v18.1.0 (March 2023), and also detailed in sections II to IV of the document by X. Lin et al. entitled “A Primer on Bandwidth Parts in 5G New Radio”, April 2020.

The functions performed by modules 3A to 3C of the UE 3 are described in more detail below, with reference to the steps of the communication method according to the disclosed technology.

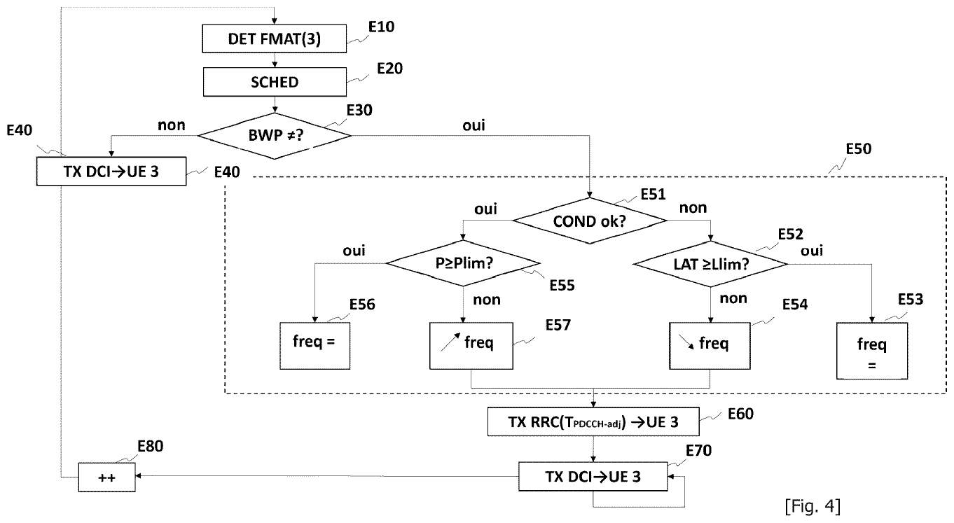

As mentioned above, it is assumed here by way of illustration that the UE 3 is connected simultaneously to the two slices SL(S1) and SL(S2), and can thus simultaneously access the services S1 and S2 offered by these slices. FIG. 4 shows the main steps of a control method according to the disclosed technology as implemented by the gNB 2 for efficiently managing the access by the UE 3 to these services S1 and S2, using the BWP functionality.

For the sake of simplicity, our description is here limited to a UL access to the services S1 and S2 by the UE 3, that is to say to the outgoing data stream sent by the UE 3 in the context of its access to each of the services via the network NW (also referred to as the outgoing data stream or outgoing traffic associated with the UE 3) to a remote entity, regardless of the location of this remote entity (in the network NW or outside the network NW). However, the disclosed technology may be applied in a similar or identical manner to the incoming data stream, that is to say in DL.

In this context, the gNB 2 initially determines, via its determination module 2A, characteristics of the outgoing traffic associated with the UE 3 (that is to say, the data streams to be transmitted in UL by the UE), relating to each service to which the UE 3 is connected and authorized to connect (services S1 and S2 for the UE 3 in the example envisaged here) (step E10). The characteristics of the outgoing traffic are determined here over a specified period of time, for example the duration of one frame (10 ms). Evidently, this example is provided solely by way of illustration, and a longer or shorter period of time may be envisaged.

More particularly, in this case, the determination module 2A estimates, for each service (or, in an equivalent manner here, each slice) to which the UE 3 is connected or authorized to connect, whether or not it takes priority (or, in an equivalent manner, its priority) and the volume (that is to say, the number of data packets) to be transmitted for the UE 3 for each QoS stream identified for this service, each QoS stream possibly consisting of multiple service data streams relating to the UE 3 having the same QoS requirements. One or more QoS streams (and, incidentally, a plurality of service data streams) may be transmitted by the UE 3 in UL for the same service (in other words, for the same slice in this case).

According to the 3GPP standard, each QoS stream is associated with a 5QI value. 5QI values are scalar numbers defined in a standardized or non-standardized way for different categories of stream (GBR (guaranteed bit rate), non-GBR (non-guaranteed bit rate) and Delay Critical GBR). Each 5QI value points to a unique QoS profile, comprising a set of values assigned to various QoS parameters to be applied to all the service data streams related to the QoS stream to which this 5QI value is assigned. These QoS parameters include, for example, a priority level, a maximum acceptable delay for a data packet (or PDB, for “Packet Delay Budget”) (latency or jitter), a packet error rate (PER), a guaranteed bit rate, a maximum bit rate, etc. More comprehensive details of 5QI values are available in the 3GPP document TS 23.501 entitled “Technical Specification Group Services and System Aspects; System Architecture for the 5G System (5GS); Stage 2 (Release 17)”, v 17.8.0 (2023 March).

A 5QI value is therefore used to characterize the QoS parameters to be met by a QoS stream associated with a service, and incidentally the service data streams related to this QoS stream. For example, a 5QI value of 1, associated with a priority level of 20, a PDB of 100 ms and a PER of 10⁻², may be used to characterize a GBR stream of a voice call service. For example, a 5QI value of 2, associated with a priority level of 40, a PDB of 150 ms and a PER of 10-3, may be used to characterize a GBR stream of a voice service.

Such a 5QI value is conventionally provided by the gNB 2 to a UE (the UE 3 here, for example) when it is attached to the gNB 2, for each service data stream that can be sent by the UE and related to a QoS stream.

Evidently, other indicators may be envisaged for characterizing the latency requirements of a service data stream associated with a UE (or of a QoS stream to which such a service data stream is related), for example a QoS class indicator (or QCI), a priority indicator reflecting the latency requirements of the stream, etc.

In the embodiment described here, the determination module 2A obtains, at the end of step E10, a matrix of outgoing QoS streams associated with the UE 3, denoted FMAT(3). The columns of this matrix represent the services (or slices in this case) to which the UE 3 is connected, while its rows correspond to the various QoS streams relating to each service, each QoS stream being associated with a 5QI value.

The matrix of QoS streams FMAT(3) obtained by the determination module 2A contains, for each service (or slice) to which the UE 3 is connected, and for each QoS stream relating to this service associated with a 5QI value, the volume of the service data streams to be transmitted (that is to say, the number of data packets to be transmitted and carried in these streams) related to this QoS stream.

For example, the matrix of QoS streams FMAT(3) takes the form shown in Table 2 at the end of step E10:

TABLE 2

| FMAT(3) | Slice SL(S1) | Slice SL(S2) |
|---|---|---|
| QoS stream DF1, value 5QI1 | nb1 | 0 |
| QoS stream DF2 Value 5QI2 | nb2 | 0 |
| QoS stream DF3 Value 5QI3 | 0 | nb3 |

where:
5QI1 and 5QI2 denote the 5QI values associated, respectively, with the QoS streams DF1 and DF2 relating to the non-priority service S1 (that is to say, the QoS streams that can be exchanged in the context of this service). The values 5QI1 and 5QI2 supply, notably, the maximum latencies (PDB delays) supported by the QoS streams DF1 and DF2 (and incidentally by the data streams related to these QoS streams). The QoS streams DF1 and DF2 comprise, respectively, nb1 and nb2 data packets (that can be carried by one or more service data streams); and
5QI3 denotes the 5QI value associated with the QoS stream DF3 relating to the priority service S2 (that is to say, the stream that can be exchanged in the context of this service). This value 5QI3 supplies, notably, the maximum latency (PDB delay) supported by the QoS stream DF3 (and incidentally by the service data streams related to this QoS stream DF3). The QoS stream DF3 comprises nb3 data packets (that can be carried by one or more service data streams).

Evidently, other forms of matrices or other data structures may be envisaged for collecting the stream characteristics determined by the determination module 2A.

The matrix of streams FMAT(3) may be determined by the module 2A according to information gathered from one or more sources.

For example, for outgoing streams, the UE 3 may supply to the module 2A of the gNB 2 the volume (number of packets) that it expects to send for each QoS stream associated with each service to which it is connected (and for each data stream related to such a QoS stream), together with the 5QI value associated with each of these QoS streams.

The module 2A may also use information held by gNB 2 for constructing the matrix FMAT(3) and for obtaining some or all of the characteristics of the outgoing traffic associated with the UE 3. In fact, the gNB 2 knows, for each slice of the network NW, the identifier (S-NSSAI) of this slice, the services offered by it, and the UEs connected to the slice. The gNB 2 can also determine, by interrogating the access and mobility function (AMF) of the network NW, the slices authorized for a particular UE following its registration in the network NW. The gNB 2 also holds the SLAs associated with each service provided by the network NW, enabling it to identify the QoS streams relating to this service and the 5QI values associated with these QoS streams (and, incidentally, the priority associated with each QoS stream and the maximum latency supported by it and by each service data stream related to this QoS stream).

The module 2A can therefore use this information, combined with any that may be supplied by the UE 3, to complete the matrix FMAT(3).

In a variant, it may also use this information about the services to which the UE 3 is connected and the priorities associated with these services, and estimate the outgoing streams and the volume of these streams by using a prediction model MOD(3) for predicting the traffic associated with the UE 3, created for each service offered by the network NW to which the UE 3 is authorized to connect (or, in an equivalent manner here, for each slice of the network NW authorized for the UE 3). There is no limitation on the nature of the prediction model that may be based on a reinforcement or deep reinforcement learning algorithm, a mathematical model, or a heuristic, etc.

In the illustrative example considered here, where the two slices SL(S1) and SL(2) are authorized for the UE 3, and only the outgoing traffic associated with the UE 3 is taken into account, such a model MOD(3) comprises two components, a first component MOD(3,S1) corresponding to a UL traffic prediction model created for the UE 3 for the service S1 (or, in an equivalent manner, for the slice SL(S1)) and a second component MOD(3,S2) corresponding to a UL traffic prediction model created for the UE 3 for the service S2 (or, in an equivalent manner, for the slice SL(S2)); i.e. MOD(3)=[MOD(3,S1); MOD(3,S2)]. Such a prediction model MOD(3) may be learnt (that is to say, constructed and updated until it converges on a stable model) in a known manner, on the basis of learning data collected in a preliminary learning phase, these learning data corresponding to the aforesaid characteristics (number of streams, associated priority level, volume) determined for the outgoing streams associated with the UE 3 during the learning phase, whenever the UE 3 is connected to a service offered by a slice of the network NW. Such learning may or may not be supervised.

In a variant, the determination module 2A may use, for each service to which the UE 3 is connected or is authorized to connect, a model for predicting the outgoing traffic associated with a plurality of UEs attached to the gNB 2 and connected, or authorized to connect, to this service (the plurality of UEs is, for example, a group of UEs connected or authorized to connect to the same slices, or all the UEs attached to the gNB 2).

Additionally, as mentioned above, in the illustrative example envisaged here, for the sake of simplicity, only the outgoing data streams, that is to say those transmitted by the UE 3, are considered for the UE 3. Assuming that there are data streams intended for the UE 3, the module 2A can obtain the characteristics of the incoming streams and complete the matrix FMAT(3) created for incoming streams, on the basis of information supplied by the remote entity that originated the incoming streams and/or on the basis of information held by the gNB 2, or by using a prediction model for the DL traffic, in a similar or identical manner to that described above for the outgoing streams.

In a variant, information for determining the matrix FMAT(3) of outgoing streams associated with the UE 3 may be obtained by the module 2A from other entities of the network NW having visibility of these streams, such as an NWDAF network function as mentioned above.

On the basis of the characteristics of the outgoing QoS streams contained in the matrix FMAT(3), the scheduling module (or “scheduler”) 2B of the gNB 2 decides on the scheduling of the data packets carried by these streams (step E20). Different types of schedulers may be envisaged in the context of the disclosed technology, such as a scheduler configured to schedule the data stream packets belonging to different slices, as described in the document by M. Raftopolou et al., entitled “Optimisation of Numerology and Packet Scheduling in 5G Networks: To Slice or not to Slice”, IEEE 93^{rd} Vehicular Technology Conference, 2021, or in the document by X. Zhang et al., entitled “RB Allocation Scheme for eMBB and uRLLC coexistence in 5G and Beyond”, Wireless Communications and Mobile Computing, vol. 2021, 11 Oct. 2021. These examples are provided solely by way of illustration, and are not limiting in themselves, since other schedulers can be used in the context of the disclosed technology, such as a scheduler based on an algorithm similar to that described in the document by Boutiba et al. cited previously, but in which the constraint requiring the use of the same BWP and the same numerology for the services S1 and S2 is relaxed.

Thus the scheduling module 2B assigns a BWP associated with a numerology μ (denoted BWP(μ)) to each QoS stream relating to the services to which the UE 3 is connected (S1 and S2 in the example envisaged here), on the basis of a knowledge of these services and of the QoS streams and their respective priorities or their respective latency requirements. The choice made by the scheduling module 2B of the bandwidth part BWP(μ) to be activated for the transmission of the QoS streams relating to a service takes into account the SLA associated with the service and the QoS profiles associated with the QoS streams: the chosen BWP and numerology p make it possible to comply with the SLA of the service and the QoS profile of the QoS streams.

In the embodiment described here, the scheduling module 2B is configured to choose the same BWP for all the QoS streams relating to the same service. For example, a bandwidth part BWP2 (extracted from the bandwidth BW(CF) allocated to the cell (CELL) associated with a high numerology μ2 (e.g. μ2=3 or 4 in Table 1), hereafter denoted BWP2(μ2), is chosen for the QoS streams relating to the priority service S2 (stream DF3), while a bandwidth part BWP1 (extracted from the bandwidth BW(CF) allocated to the cell (CELL) associated with a lower numerology μ1 (e.g. μ1=0 or 1 in Table 1), hereafter denoted BWP1(μ1), is chosen for the streams DF1 and DF2 relating to the non-priority service S1.

However, as mentioned above, it would be possible to envisage choosing different BWPs for transmitting the QoS streams relating to the same service if that is appropriate in view of the QoS profiles associated with these QoS streams.

It should be noted that, for the choice of the BWP and numerology suitable for each service to which the UE 3 is connected (or for each QoS stream relating to a service to which the UE 3 is connected), the scheduling module 2B may be configured to examine, in the first place, whether the current active BWP at the UE 3, and the numerology associated with this current active BWP, may be used to transmit the QoS streams associated with this service (or this QoS stream, respectively); in other words, to examine whether they comply with the SLA of the service (or the QoS profile associated with the QoS stream, respectively). If necessary, this BWP and the associated numerology p may be preferred for the service (or for the QoS stream respectively) in question, to avoid a change of bandwidth part.

Additionally, the scheduling module 2B assigns, for each QoS stream of the matrix of streams FMAT(3) corresponding to non-zero traffic:
a set of PRBs for the transmission of the data packets of the service data streams relating to this QoS stream in the BWP assigned to the service to which this QoS stream relates; and
instants of transmission (TTIs) of these PRBs.

By way of illustration, let us assume that the scheduling performed by the module 2B results in the allocation of the following resources: the nb1 data packets of the QoS stream DF1 are distributed over the TTIs T0(1), T1(1), . . . , TX(1) on BWP1(μ1), then the nb2 data packets of the QoS stream DF2 are distributed over the TTIs T0(2), T1(2), . . . , TX(2) on BWP1(μ1), and then the nb3 data packets of the stream DF3 are distributed over the TTIs T0(3), T1(3), . . . , TX(3) on BWP2(μ2). The resources thus allocated by the module 2B are transferred to the matrix of outgoing streams FMAT(3) in this case. This matrix of outgoing streams FMAT(3) therefore represents the future UL activity of the UE 3 over the period of time considered (in this case, one frame). It should be noted that, in the absence of UL traffic over this period of time for the UE 3, the matrix of outgoing streams FMAT(3) may be zero.

It is also assumed that, before sending the stream DF1, the current active BWP used for the UL transmissions of the UE 3 is the UL BWP defined by default and denoted BWP0(μ0=0).

The adjustment module 2C of the gNB 2 then examines whether one or more changes of BWP are required in view of the scheduling performed by the scheduling module 2B in order to transmit the outgoing traffic of the UE 3 (test step E30).

In the embodiment described here, if the module 2C determines that no change of BWP is required (the answer in test step E30 is “no”), then the gNB 2, via its sending module 2E, informs the UE 3 of the resources allocated to it for the transmission of its outgoing traffic (step E40). For this purpose, the sending module 2E sends DCI control information intended for the UE 3 (according to the 0_1 or 0_0 format described in the previously cited 3GPP document TS 38.212, for example), identifying these resources in the PDCCH channel. This sending is locked to the current period T_{PDCCH} with which the UE 3 periodically monitors the PDCCH channel so that the UE 3 can detect and decode this DCI information.

In the illustrative example envisaged here, the result of the test step E30 is:
that a change of BWP is required, from the current BWP0(μ0) to BWP1(μ1), for transmitting the data packets of the stream DF1;
that no change of BWP from BWP1(μ1) is required for transmitting the data packets of the stream DF2; and
that a change of BWP is again required, from BWP1(μ1) to BWP2(μ2), for transmitting the data packets of the stream DF3.

In other words, in the test step E30, the adjustment module 2C detects that two changes of BWP are required (the answer at test step E30 is “yes”).

According to the 3GPP standard, each change of BWP is notified by the gNB 2 to the UE 3 by sending DCI control information in the 0_1 format (for UL transmissions) to the UE 3 over the PDCCH control channel. This DCI control information comprises the BWP indicator designating the new bandwidth part to be activated by the UE 3 and the associated numerology for the data transmission, to replace the current active bandwidth part and numerology.

According to the disclosed technology, before the BWP indicators are sent, the adjustment module 2C examines whether an adjustment of the frequency of monitoring of the PDCCH channel by the UE 3 is appropriate, and, if so, evaluates the extent (i.e. the size) of this adjustment (step E50). It should be noted that this examination can be carried out even if no change in BWP is required at the UE 3 and therefore if no BWP indicator is sent by the gNB 2 for the frame in which the outgoing traffic associated with the UE 3 was considered.

In the embodiment described here, in step E50, the adjustment module 2C examines a number of conditions relating, on the one hand, to the characteristics of the outgoing streams associated with the UE 3 to be transmitted, and also, in this case, to one or more performance indicators of the UE 3 and/or of the network NW.

More precisely, the adjustment module 2C initially determines whether at least two separate bandwidth parts are assigned to the UE 3 for the transmission of the identified outgoing QoS streams (corresponding to non-zero traffic) in the matrix of the outgoing streams FMAT(3) (and therefore for the service data streams relating to these QoS streams) and whether at least one service to which the UE 3 is connected and/or at least one outgoing QoS stream of the matrix FMAT(3) (and therefore, incidentally, at least one service data stream relating to this QoS stream) is identified as taking priority or associated with a maximum latency below a given threshold (step E51). This threshold is chosen so as to reflect a high requirement in terms of latency: here, for example, it is taken to be 1 ms.

If this condition is not met (if the answer in step E51 is “no”), for example all the services to which the UE 3 is connected are identified as non-priority or accept a maximum latency above a given threshold (a latency that is considered to be rather low) or all the QoS streams identified in the matrix of outgoing streams FMAT(3) (and therefore, incidentally, all the service data streams relating to these QoS streams) are identified as non-priority by the gNB 2 (or as non-demanding in terms of latency), or, again, the same BWP is assigned to all the services to which the UE 3 is connected and to all the outgoing streams of the matrix of streams FMAT(3) (and therefore incidentally to all the service data streams relating to these QoS streams), the adjustment module 2C examines whether the current frequency of monitoring of the PDCCH channel by the UE 3 can be reduced in order to decrease the power consumption of the UE 3. Such a reduction results in a decrease in the monitoring and decoding processing of the PDCCH channel implemented by the UE 3, and therefore a decrease in the power consumption of the latter.

For this purpose, the adjustment module 2C determines whether the end-to-end latency of the network for each service to which the UE 3 is connected (S1 and S2 in the example envisaged here) reaches or exceeds a limit value Llim defined for this service, corresponding to the maximum latency accepted by this service (test step E52). This limit value is extracted by the gNB 2 for each service of its SLA. The end-to-end latency of the network for each service to which the UE 3 is connected can be measured by the UE 3 and supplied by the latter to the gNB 2, or, in a variant, can be estimated by the gNB 2.

If the limit value Llim is reached or exceeded for any of the services (if the answer in the test step E52 is “yes”), the current monitoring frequency is kept as it stands (i.e. there is no adjustment) (step E53). In fact, while a reduction of the monitoring frequency would enable the power consumption of the UE 3 to be reduced, it would also result in an increased end-to-end latency of the network for this service, which would adversely affect the quality of the service.

The gNB 2, via its sending module 2E, then informs the UE 3 of the resources allocated to it for the transmission of its outgoing traffic, as described previously for step E40.

If the limit value Llim is not reached for any of the services to which the UE 3 is connected (if the answer in test step E52 is “no”), the adjustment module 2C reduces the current monitoring frequency, for example by increasing by a specified number of slots the period T_{PDCCH} with which the UE 3 periodically monitors the PDCCH channel (step E54). This advantageously makes it possible to economize on the network resources and the power consumption of the UE 3.

To determine the amount by which the monitoring frequency should be reduced, that is to say to “design” the reduction to be applied to the monitoring frequency (in the example envisaged above, by evaluating the number of slots to be added to the period T_{PDCCH}), the module 2C may proceed by trial and error, in an iterative manner, for example by adding one or more slots on each iteration to the period T_{PDCCH} for as long as the resulting end-to-end latency of the network remains below the limit value Llim defined for this service. T_{PDCCH-adj} denotes the maximum period that allows the constraint of end-to-end latency to be met. This period T_{PDCCH-adj}, adjusted relative to the value T_{PDCCH}, is representative of the adjusted monitoring frequency.

It should be noted that steps E52 to E54 are optional, and are intended to optimize the resources of the network NW and of the UE 3. Thus, in a variant embodiment, if the services relating to the outgoing streams associated with the UE 3 do not have different priorities or different quality of service requirements, the frequency of monitoring of the PDCCH channel by the UE 3 is kept as it stands (no adjustment). The adjustment module 2C may also be configured to implement steps E52 to E54 described above, if, at step E30, the module 2C determines that no change in BWP is required by the scheduling proposed by the module 2B.

If the condition examined in step E51 is met (if the answer in test step E51 is “yes”), the adjustment module 2C examines whether an increase in the current monitoring frequency is possible, in order to reduce the latency due to the change of BWP, and to improve the quality of service of the services and/or the streams of the highest priority or those with the highest requirements in terms of latency. Such services are, for example, identified as priority services because of their latency requirements (e.g. uRLLC or V2X services), or because they are associated with QoS streams having high 5QI values, above a given threshold (above 82, for example). Similar considerations apply to the QoS streams and to the service data streams.

For this purpose, the adjustment module 2C determines whether the power consumption of the UE 3 has reached or exceeded a limit value Plim (test step E55). The power consumption of the UE 3 is a measurement made by the UE 3, conventionally reported to the gNB 2 and available to the gNB 2. The limit value Plim represents the value of the maximum power that the UE 3 is authorized to consume; it is known by the gNB 2 and defined by the operator of the network NW in view of the statutory limits.

If the power consumption of the UE 3 reaches or exceeds its limit value Plim (if the answer in the test step E55 is “yes”), the current monitoring frequency is kept as it stands (no adjustment) (step E56). This is because an increase in the monitoring frequency would result in an increase in the power consumption of the UE 3, which could be harmful for the user of the UE 3.

The gNB 2, via its sending module 2E, then informs the UE 3 of the resources allocated to it for the transmission of its outgoing traffic, as described previously for step E40.

Otherwise (if the answer in test step E55 is “no”), the adjustment module 2C increases the current frequency of monitoring of the PDCCH control channel by the UE 3, for example by reducing the period T_{PDCCH} by a specified number of slots (step E57). To evaluate the increase to be applied to the current monitoring frequency (in other words, in the example envisaged here, the number of slots to be subtracted from the period T_{PDCCH}), the module 2C may proceed by trial and error, for example by reducing the period T_{PDCCH} by one slot in each iteration, as long as the power consumption of the UE 3 remains below its value Plim. T_{PDCCH-adj} denotes the minimum period allowing the constraint of power consumption of the UE 3 to be met. This period T_{PDCCH-adj}, adjusted relative to the value T_{PDCCH}, is representative of the adjusted monitoring frequency.

Other ways of determining whether an adjustment of the current monitoring frequency is appropriate, and evaluating this adjustment if necessary, may be implemented by the adjustment module 2C in step E50, taking into account the characteristics of the streams associated with the UE 3 collected in the matrix FMAT(3), and, if necessary, other factors such as performance indicators of the UE 3 and/or of the network NW. For example, the adjustment module 2C may use artificial intelligence (AI) or a machine learning (ML) algorithm, or a heuristic algorithm or one based on game theory, to which the characteristics of the streams, and if necessary the performance indicators, are supplied as input parameters.

Furthermore, quantities representative of the monitoring frequency other than the period with which the UE 3 monitors the PDCCH channel may be considered, for example the inverse of this period (frequency).

If, during step E50, an adjustment of the frequency of monitoring of the PDCCH channel by the UE 3 has been decided on (steps E54 and E57), then the adjusted monitoring frequency is notified to the UE 3 by the gNB 2 via its notification module 2D (step E60). For this purpose, the notification module 2D uses, for example, an RRC message for reconfiguring the UE 3 with the adjusted monitoring frequency, so that it implements it for the monitoring of the PDCCH channel (i.e. so that it becomes the current monitoring frequency used by the UE 3). More particularly, this RRC message is used by the gNB 2 to modify the value of the monitoringSlotPeriodicityAndOffset field, which defines the periodicity with which the UE 3 must scan a specified frequency band (defined by CORESET) in order to detect the PDCCH channel carrying the information (including the DCI control information) intended for it. In other words, the monitoringSlotPeriodicityAndOffset field defines the value of the period T_{PDCCH}. The modification of the field with the value T_{PDCCH-adj} enables the UE 3 to be informed of the new monitoring frequency to be applied.

It should be noted that reducing (decreasing) the monitoring frequency of the UE 3 has an effect on the frequency at which the gNB 2 can send information to the UE 3 in the PDCCH control channel, particularly DCI control information carrying a BWP indicator. The gNB 2 must take into account this reduction when sending DCI information on the PDCCH control channel to the UE 3, to ensure that the UE 3 can detect and decode this information. Depending on the adjustment made by the module 2C, the UE 3 will only be able to detect and decode this information at intervals more widely spaced in time than in its original configuration, if a reduction of the monitoring frequency has been implemented, or, conversely, more closely spaced in time, if an increase in the monitoring frequency has been implemented. Thus, following the step E60 of RRC reconfiguration of the UE 3 with the adjusted monitoring frequency, the gNB 2 is configured to send DCI information in the PDCCH channel according to this adjusted monitoring frequency (step E70).

The result is, advantageously, that if a change of BWP is required (for the transmission of data packets of streams DF1 and DF2, for example) and the monitoring frequency has been increased, the gNB 2 can inform the UE 3 more rapidly of the new BWP to be activated by the UE 3, by sending DCI control information in the 0_1 format over the PDCCH control channel. The DCI information also contains the resources allocated to the UE 3 by the scheduling module 2B for the transmission of the outgoing traffic from the UE 3. Any other subsequent change in the BWP (for the transmission of data packets of the DF3 stream, for example) is signaled in an identical manner to the UE 3 (in the example envisaged, with the resources allocated to the UE 3 on this new BWP for the transmission of the data packets of the DF3 stream).

Steps E10 to E70 of the control method described above are reiterated several times by the gNB 2 (step E90), periodically in the embodiment described here, for example with each new frame (i.e. every 10 ms in this case), as long as the UE 3 is connected to the gNB 2. Evidently, a different period may be envisaged. Furthermore, in another embodiment, steps E10 to E60 may be triggered on the detection of a particular event, for example the connection of the UE 3 to a new slice or a new service, or any other event that may modify the characteristics of the matrix of streams FMAT(3) of the UE 3.

FIG. 5 describes the steps of the communication method implemented by the UE 3 in a particular embodiment, when the monitoring frequency of the PDCCH control channel by the UE 3 has been adapted by the gNB 2 (steps E54 and E57 of FIG. 4). It should be noted that, if the monitoring frequency has not been adapted, the UE 3 operates in a conventional manner, as described in previous approaches and as specified by the 3GPP standard.

As described above, the adjusted monitoring frequency is notified to the UE 3 by the gNB 2 via its notification module 2D at step E60, by means of an RRC message which here contains the period T_{PDCCH-adj}. This RRC message is received by the obtaining module 3A of the UE 3 (step F10).

Following the reception of the RRC message, the UE 3, and more particularly its monitoring module 3B in this case, is reconfigured with the value of the period T_{PDCCH-adj} representative of the adjusted monitoring frequency for monitoring the PDDCH channel (step F20).

Following this reconfiguration, the monitoring module 3B monitors the PDCCH channel at the adjusted monitoring frequency (step F30). In other words, once every T_{PDCCH-adj}, it scans the PDCCH channel to detect whether information intended for it, and particularly DCI control information, has been transmitted for its attention in the PDCCH channel by the gNB 2. If necessary, it decodes this information and uses or executes it, depending on the nature of the information.

For example, after the gNB 2 has sent, in step E70, the DCI control information including the resources allocated to the UE for the transmission of the DF1 and DF2 streams and the BWP indicator designating BWP1(μ1), the UE 3 activates BWP1(μ1) via its activation module 3C and switches to this BWP1(μ1) to transmit the data streams DF1 and DF2 according to the resources that have been allocated to it and within the maximum period authorized by the 3GPP standard indicated in paragraph 8.6 of 3GPP document TS 38.133 entitled “Technical Specification Group Radio Access Network; NR; Requirements for support of radio resource management (Release 17”, v17.8.0 (2022 December) (step F40).

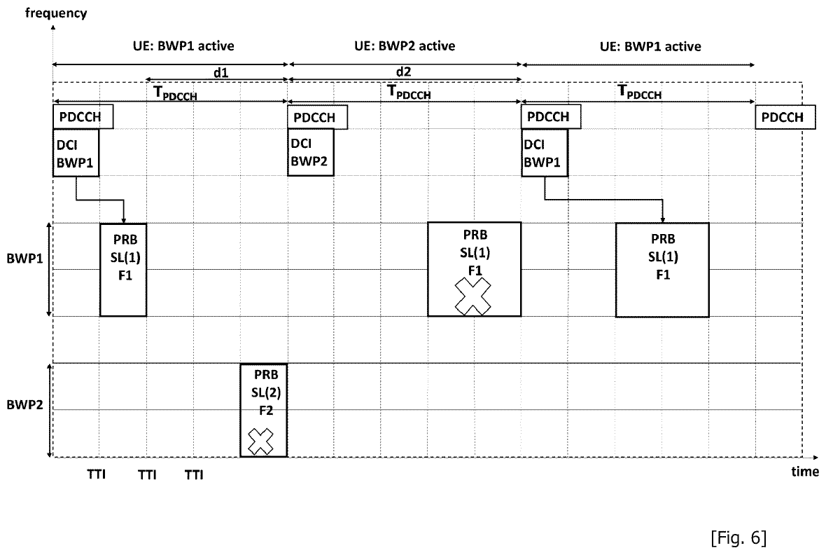

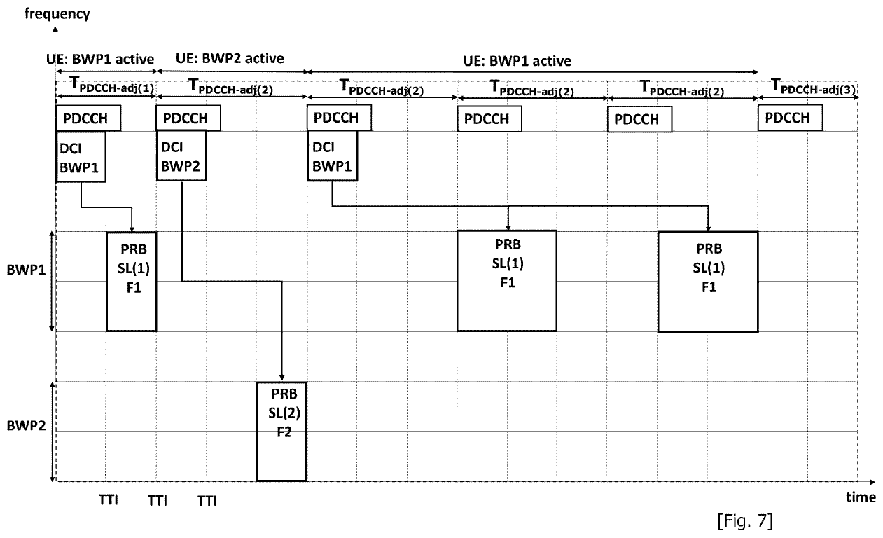

FIGS. 6 and 7 show, in a simple example, the benefits brought by the disclosed technology.

This example envisages the transmission for a UE of a data stream F1 relating to a service offered by the slice SL(1) over a bandwidth part BWP1 and of a data stream F2 relating to a service offered by a slice SL(2) over a bandwidth part BWP2, the service offered by the slice SL(2) being of higher priority (e.g. uRLLC) than the service offered by the slice SL(1) (e.g. eMBB).

FIG. 6 shows, in the absence of the implementation of the disclosed technology, the timing of the DCI information sent to the UE for the transmission of the streams F1 on BWP1 and F2 on BWP2, and the way in which this DCI information is used by the UE 3. In FIG. 6, the period T_{PDCCH} of monitoring of the PDCCH channel by the UE 3 is fixed, and considered to be equal to 5 slots or TTIs.

In this context, some packets of the F1 and F2 streams (marked with a cross in FIG. 6) cannot comply with the scheduling (PRB, TTI and BWP) specified to guarantee the SLA of the services offered by the slices SL(1) and SL(2), resulting in a degraded quality of service for the services offered by the two slices. In fact, d1 denotes the time remaining after transmission on BWP1 of packets of the stream F1 until the next PDCCH control channel comprising DCI information for switching from BWP1 to BWP2; consequently, data packets relating to the stream F2, specified by the scheduling for transmission before the expiry of d1, cannot be transmitted on BWP2. The same applies after the switch to BWP2 for the transmission of data packets relating to the stream F1 specified by the scheduling for transmission before the expiry of d2, where d2 denotes the wait time for switching from BWP1 to BWP2.

FIG. 7 shows the timing of the DCI information sent to the UE 3 for the transmission of the streams F1 and F2, and the way in which this DCI information is used by the UE 3, when the disclosed technology is implemented. In this FIG. 7, the period T_{PDCCH}, initially set at 5 slots, is adjusted to 2 slots (T_{PDCCH-adj(1)}), then to 3 slots (T_{PDCCH-adj(2)}), then again to 2 slots (T_{PDCCH-adj(3)}). In this context, all the packets of the streams F1 and F2 can be transmitted according to the scheduling, and the quality of the services offered by the slices SL(1) and SL(2) is guaranteed.

In the embodiment described here, for the sake of simplicity, only the outgoing data streams, that is to say the UL streams, are considered. However, the disclosed technology is also applicable to incoming data streams sent to the UE (that is to say, in DL), and those skilled in the art would not find it difficult to adapt the description given above to the transmission of incoming data streams, by applying the description given above for the UL data streams to the DL data streams in a similar or identical manner.

The disclosed technology is also applicable when the traffic associated with the user equipment comprises incoming (DL) data streams and outgoing (UL) data streams, regardless of the multiplexing technique considered between UL and DL (TDD or FDD). This is because the disclosed technology is applied individually (independently) to each channel. However, it should be noted that, since the PDCCH channel is capable of carrying DCI control information relating to both UL and DL transmissions, if the application of the disclosed technology in UL and the application of the disclosed technology in DL lead to a different adjustment of the monitoring frequency, then the highest of the two adjusted monitoring frequencies is chosen for application to the user equipment.

Additionally, in the embodiment described above, the entity of the 5G NR network according to the disclosed technology configured to implement the control method according to the disclosed technology is a gNB base station. The disclosed technology is equally applicable to other network architectures, particularly to an Open-RAN architecture as defined by the O-RAN Alliance.

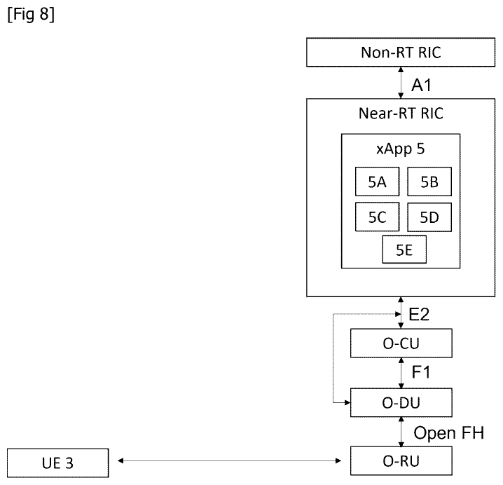

In a known manner, Open-RAN, or Open Radio Access Network, offers a development of mobile network architectures based on a fully programmable radio access network consisting of virtualized and disaggregated functions. Typically, as illustrated in FIG. 8, for a 5G NR RAN, the base station or gNB is disaggregated into multiple radio unit (O-RU, for “Open Radio Unit”), distributed unit (O-DU, for “Open Distributed Unit”) and centralized unit (O-CU, for “Open Centralized Unit”). The interfaces between these units (e.g. A1, E1, E2, etc.) are open and interoperable. Each unit is responsible for a specific function and protocol layer. For example, the O-RU unit is responsible for the lower physical layer (processes such as FFT, beamforming, etc.), while the O-DU unit is responsible for scheduling, the higher physical layer and layer 2, including the MAC (Medium Access Control) layer.

In this architecture, the RAN functions are controlled and optimized by means of an intelligent software controller or RIC (RAN Intelligent Controller). The RIC is present in two logical forms, each implementing a different function:
a Non-RT RIC (Non-Real Time RIC), responsible, notably, for managing the configurations, devices, faults, performance and life cycles of all the elements in the network, using intelligent algorithms (e.g. AI or ML) operating on a timescale of more than 1 s; and
a Near-RT RIC (Near-Real Time RIC), which hosts a large number of micro-services or xApps, based on algorithms operating on a timescale between 10 ms and 1 s. The control of the PDCCH channel monitoring frequency by the UE according to the disclosed technology comes into this category of algorithms, and can thus, in another embodiment, be implemented by an xApp 5 hosted by the Near-RT RIC. The xApp 5 is a (software) entity of the network according to the disclosed technology, comprising functional modules 5A to 5E similar or identical to the functional modules 2A to 2E of the gNB 2, described above. They are not described in further detail here.

Steps E10 to E70 described above are implemented by the xApp 5, in this other embodiment, in a similar or identical fashion to that described previously for the gNB 2, but involve communication interfaces belonging to the Open-RAN architecture. The same applies for steps F10 to F30 implemented by the UE 3.

Thus, in this other embodiment, the information from the UE 3 and the AMF used by the xApp 5, and if necessary other entities of the network NW, to construct the matrix of the streams FMAT(3) as described in step E10 are obtained by the xApp 5 via an interface E2. The adjusted monitoring frequency is also supplied by the xApp 5 to the UE 3 via this interface.

If the use of a traffic prediction model for the UE 3 is envisaged for the purpose of obtaining the matrix of the streams FMAT(3), the phase of learning and the determination of matrix of the streams FMAT(3) by means of this prediction model are implemented in the Non-RT RIC that manages the AI or ML algorithms. The resulting matrix of streams FMAT(3) is then transmitted to the xApp 5 hosted in the Near-RT RIC via the interface E1, which takes the appropriate decisions, according to the disclosed technology, concerning the adjustment of the frequency f_{PDCCH} of the monitoring of the PDCCH channel by the UE 3.

In yet another embodiment, the network entity according to the disclosed technology is hosted in the Non-RT RIC. In this case, the same interfaces as those described above are used.

What is claimed is:

1. A method for controlling, by an entity of a telecommunications network, a monitoring frequency, at which a user equipment monitors a control channel capable of carrying at least one indicator of a bandwidth part assigned to said user equipment, said control method comprising:
a step of adjusting said monitoring frequency, according to at least one characteristic of at least one data stream to be transmitted associated with said user equipment and relating to at least one service offered by the network;
a step of notifying said adjusted monitoring frequency to said user equipment; and
a step of sending information intended for the user equipment over said control channel according to said adjusted monitoring frequency.

2. The method of claim 1, wherein the steps of adjusting the monitoring frequency, notifying and sending are reiterated periodically.

3. The method of claim 1, wherein said information intended for the user equipment comprises at least one indicator of a bandwidth part assigned to the user equipment to be activated for the transmission of said at least one data stream.

4. The method of claim 1, wherein, in the adjustment step, said monitoring frequency is also adjusted according to at least one performance indicator of said user equipment and/or of the network.

5. The method of claim 4, wherein said at least one performance indicator comprises:
a power consumption of said user equipment; and/or
an end-to-end data rate or latency of the network.

6. The method of claim 1, wherein the adjustment step comprises increasing the monitoring frequency when at least two separate bandwidth parts are assigned to said user equipment for the transmission of said at least one data stream and when at least one said service and/or at least one said data stream is identified as taking priority or as being associated with a maximum latency below a given threshold.

7. The method of claim 1, wherein the adjustment step comprises reducing the monitoring frequency when one of the following conditions is met:
the same bandwidth part is assigned to said user equipment for the transmission of said at least one data stream;
said at least one service comprises only one or more services identified as non-priority or associated with a maximum latency above a given threshold; or
said at least one stream comprises only one or more streams identified as non-priority or associated with a maximum latency above a given threshold.

8. The method of claim 1, wherein said at least one characteristic comprises, for a said data stream associated with a said service:
a volume of said data stream; and/or
information about a scheduling of the data packets carried by said data stream and about a bandwidth part assigned to said service for the transmission of said data packets; and/or
a priority associated with said service; and/or
a priority associated with said data stream and/or a maximum latency associated with said data stream; and/or
a network slice associated with said service.

9. The method of claim 1, wherein said at least one service comprises at least one of the following services:
an “ultra Reliable Low Latency Communication” (uRLLC) service;
an “enhanced Mobile BroadBand” (eMBB) service;
a “massive Machine Type Communication” (mMTC) service;
a “Vehicle to Everything” (V2X) service;
a “High Performance Mobile Type Communication” (HMTC) service.

10. The method of claim 1, further comprising a step of estimating said at least one characteristic of said at least one data stream to be transmitted, associated with said user equipment on the basis of at least one of the following elements:
at least one identifier of at least one network slice to which said user equipment is attached or which is authorized for said user equipment, and/or at least one service to which said user equipment is connected or is authorized to connect; and
at least one piece of information supplied by said user equipment.

11. The method of claim 1, further comprising a step of learning a traffic prediction model for said user equipment, this prediction model being used by said network entity for determining said at least one characteristic of said at least one stream to be transmitted associated with said user equipment.

12. A method of communication by a user equipment of a telecommunications network, said method comprising:
a step of receiving a notification of what is known as a monitoring frequency at which said user equipment monitors a control channel, adjusted by a network entity according to an adjustment step of a control method as claimed in claim 1, said control channel being capable of carrying at least one indicator of a bandwidth part assigned to said user equipment; and
a step of monitoring said control channel according to said adjusted monitoring frequency.

13. The method of claim 12, further comprising, in said monitoring step, detecting in said control channel at least one indicator of a bandwidth part assigned to the user equipment to be activated.

14. The method of claim 12, wherein said notification is an RRC (radio resource control) configuration message, sent by the network entity and comprising a value of a period with which the monitoring of the control channel is to be reiterated.

15. An entity of a telecommunications network, comprising:
an adjustment module, configured to adjust, according to at least one characteristic of at least one data stream to be transmitted associated with a user equipment and relating to at least one service offered by said network, a quantity representing a frequency of monitoring a control channel capable of carrying at least one indicator of a bandwidth part assigned to said user equipment;
a notification module, configured to notify said adjusted monitoring frequency to said user equipment; and
a sending module, configured to send information intended for the user equipment over said control channel according to said adjusted monitoring frequency.

16. A user equipment of a telecommunications network, comprising:
a reception module, configured to receive a notification of a monitoring frequency at which said user equipment monitors a control channel, adjusted by an adjustment module of a network entity as claimed in claim 15, said control channel being capable of carrying at least one indicator of a bandwidth part assigned to said user equipment; and
a monitoring module, configured to monitor said control channel according to said adjusted monitoring frequency.

17. A communication system comprising:
the network entity of claim 15; and
a user equipment of a telecommunications network, comprising:
a reception module, configured to receive a notification of a monitoring frequency at which said user equipment monitors a control channel, adjusted by an adjustment module of the network entity, said control channel being capable of carrying at least one indicator of a bandwidth part assigned to said user equipment; and
a monitoring module, configured to monitor said control channel according to said adjusted monitoring frequency.
